(19) United States
(12) Patent Application Publication
(10) Pub. No.: US 2005/0047487 A1
(43) Pub. Date: Mar. 3, 2005

(54) SPREAD SPECTRUM COMMUNICATION SYSTEM RECEIVING DEVICE

(75) Inventors: Mikio SAKAUE, Tokyo (JP); Hidenori TOMISHIMA, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: GCOMM CORPORATION, Tokyo (JP)

(21) Appl. No.: 10/710,127

(22) Filed: Jun. 21, 2004

(30) Foreign Application Priority Data
Sep. 1, 2003 (JP) 2003-347565

(51) Int. Cl. H04B 1/707

(52) U.S. Cl. 375/148

(57) ABSTRACT

A received signal whose frequency band is spread in a spread spectrum system is subjected to fast Fourier transform processing to be transformed to a frequency spectrum, based on this frequency spectrum, a narrow-band interference signal is detected and eliminated, and then by subjecting the received signal to inverse FFT, the received signal from which the interference signal is eliminated is obtained, whereby the narrow-band interference signal can be eliminated from the received signal by a simple configuration.

### CROSS REFERENCE TO RELATED APPLICATIONS

This application is based upon and claims the benefit of priority from the prior Japanese Patent Application No. 2003-347565, filed on Sep. 1, 2003, the entire contents of which are incorporated herein by reference.

### BACKGROUND OF THE INVENTION

1. Field of the Invention

The present invention relates to elimination of a narrow-band interference signal in a spread spectrum system communication device.

2. Description of the Related Art

In spread spectrum communication, communication is performed by spreading a transmitted signal over a much wider frequency band than a frequency band of the transmitted signal. The spread spectrum communication is, in principle, excellent in fading characteristic and capable of high-speed communication, whereby, in recent years, its application field has been expanding, including a cellular phone and a wireless LAN.

It is expected that the application field of radio communication will further expand by adopting a spread spectrum system also in radio communication equipment, which utilizes weak radio waves, while using its characteristic to the full. However, in the case of a weak radio wave which does not have a frequency band provided for a specific communication service such as a cellular phone, interference characteristics are an important problem.

In particular, in a spread spectrum system with a wide occupied bandwidth, the probability of the existence of a narrow-band or a single-frequency interference radio wave within a frequency band used for communication is high, and it is necessary to eliminate the interference radio wave. Improvements in such interference characteristics are effective on the spread spectrum communication system in terms of an improvement in communication quality without being limited to the weak radio wave.

The elimination of an interference signal has been hitherto devised, and it is disclosed in Japanese Patent No. 2753565, Japanese Patent Application Laid-open No. Hei 2-182045, and so on. However, in arts described in these documents, a means for detecting the interference signal is complicated, which makes it impossible to configure a device at low cost. Moreover, when there are plural narrow-band or single-frequency interference signals whose frequencies are apart from one another, it is impossible to eliminate all of the interference signals.

### SUMMARY OF THE INVENTION

An object of the present invention is to provide a spread spectrum system communication device capable of eliminating all of plural narrow-band interference signals in communication.

To attain the aforementioned object, a spread spectrum communication system receiving device of the present invention is a spread spectrum communication system receiving device for receiving a signal transmitted in a spread spectrum communication system, the receiving device comprising: an A/D converter for converting a received signal to digital data; a Fourier transformer for subjecting the digital data outputted from the A/D converter to fast Fourier transform and detecting a frequency component associated with an interference signal from the obtained frequency spectrum of the received signal; a noise eliminator for eliminating the frequency component associated with the interference signal based on a result of the detection in the Fourier transformer; an inverse Fourier transformer for subjecting an output from the noise eliminator to inverse fast Fourier transform; an inverse spread processor for subjecting an output from the inverse Fourier transformer to inverse spread processing; and a demodulator for subjecting an output from the inverse spread processor to demodulation processing.

According to the aforementioned configuration, an interference signal (narrow-band interference signal) is detected and eliminated in a state in which a received signal is subjected to fast Fourier transform processing to be transformed to a frequency spectrum, and then by subjecting the received signal to inverse fast Fourier transform processing, the received signal from which the interference signal is eliminated can be obtained, whereby a spread spectrum communication system receiving device capable of eliminating plural narrow-band interferences can be provided. Accordingly, single-frequency and narrow-band noise in the received signal can be eliminated, which leads to an improvement in the communication quality of spread spectrum communication.

Moreover, the interference signal is detected and eliminated by digital processing, which makes it possible to facilitate the IC implementation of the device, and consequently, a low-cost spread spectrum communication system receiving device with a stable performance can be provided.

### BRIEF DESCRIPTION OF THE DRAWINGS

FIG. 1 is a block diagram showing an example of the configuration of a spread spectrum system communication device according to an embodiment;

FIG. 2 is a diagram showing an example of the spectrum of a spread signal and interference signals;

FIG. 3 is a diagram showing the spectrum of the spread signal and interference signals frequency-converted to baseband;

FIG. 4 is a diagram showing the spectrum of a baseband signal from which the interference signals are eliminated; and

FIG. 5 is a block diagram showing an example of the concrete configuration of the spread spectrum system communication device according to this embodiment.

### DETAILED DESCRIPTION OF THE PREFERRED EMBODIMENTS

Hereinafter, an embodiment of the present invention will be described based on the drawings.

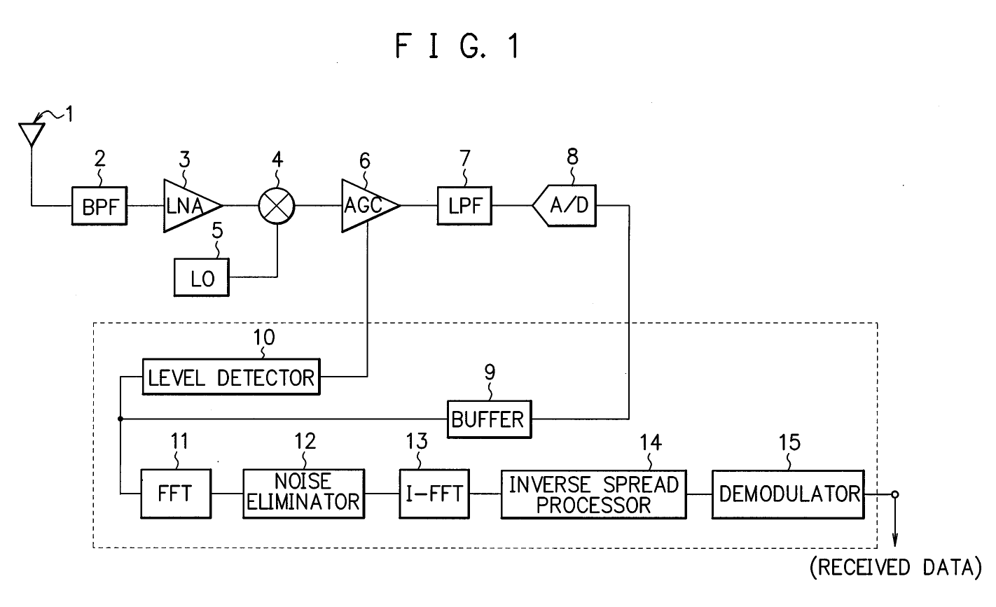

FIG. 1 is a block diagram showing an example of the configuration of a spread spectrum system communication device, and more specifically, receiving device according to the embodiment of the present invention.

A high-frequency received signal received by an antenna 1 in the spread spectrum system receiving device shown in FIG. 1 is inputted from the antenna 1 to a band-pass filter (BPF) 2, and its unnecessary frequency band is eliminated by the band-pass filter 2. Thereafter, the high-frequency received signal is amplified by a low-noise amplifier (LNA) 3.

A mixer 4 performs frequency conversion by mixing the high-frequency received signal amplified by the low-noise amplifier 3 with an output from a local oscillator (LO) 5. In this embodiment, a direct conversion system is shown as an example. Hence, an output frequency (frequency of an output signal) of the local oscillator 5 is equal to a received frequency, and the high-frequency received signal is directly converted to a baseband signal by the mixer 4.

The baseband signal obtained by the conversion by the mixer 4 is amplified by a variable gain amplifier (AGC) 6, and its unnecessary high-frequency component (or components) is (or are) eliminated by a low-pass filter (LPF) 7.

The received signal (baseband signal) processed by the low-pass filter 7 is inputted to an analog-digital converter (A/D converter) 8 and converted to digital data.

The received signal (time-axis data) converted to the digital data by the A/D converter 8 is supplied to a fast Fourier transform (FFT) processor 11 via a buffer 9, and transformed into frequency-axis data in the FFT processor 11. By transforming the received signal of the time-axis digital data into the frequency-axis digital data in the FFT processor 11, a spectrum of a single-frequency or narrow-band interference signal in the received signal is detected.

The spectrum of the interference signal detected in the FFT processor 11 is eliminated by a noise eliminator 12. The noise eliminator 12, for example, eliminates a signal of a frequency having energy equal to or larger than predetermined energy (energy of a spread signal associated with communication) in a frequency band of the received signal.

The received signal whose interference signal frequency component (or components) is (or are) eliminated in the noise eliminator 12 is returned again from the frequency-axis data to the time-axis data in an inverse fast Fourier transform (I-FFT) processor 13. The received signal returned to the time-axis data in the I-FFT processor 13 is subjected to inverse spread processing in an inverse spread processor 14 and demodulated in a demodulator 15. Thus, the interference signal frequency component (or components) is (or are) eliminated from the high-frequency received signal received by the antenna 1, and then the high frequency received signal is subjected to the inverse spread processing and demodulation processing to obtain the receive data.

The buffer 9 here is a dual page memory. Since the aforementioned processing performed sequentially by the FFT processor 11, the noise eliminator 12, and the I-FFT processor 13 is batch processing, the buffer 9 is provided in such a manner that digital received signals inputted continuously during this processing time are temporarily held so as not to be lost. A level detector 10 controls the gain of the variable gain amplifier 6 according to the signal level of the received signal.

Note that the processing in each of the buffer 9, the level detector 10, the FFT processor 11, the noise eliminator 12, the I-FFT processor 13, the inverse spread processor 14, and the demodulator 15 which are provided at a stage subsequent to the A/D converter 8 is digital processing. In other words, the buffer 9, the level detector 10, the FFT processor 11, the noise eliminator 12, the I-FFT processor 13, the inverse spread processor 14, and the demodulator 15 which are enclosed by a dotted line in FIG. 1 are each composed of a digital circuit (for example, a CPU, a DSP (digital signal processor), or any other digital arithmetic circuit).

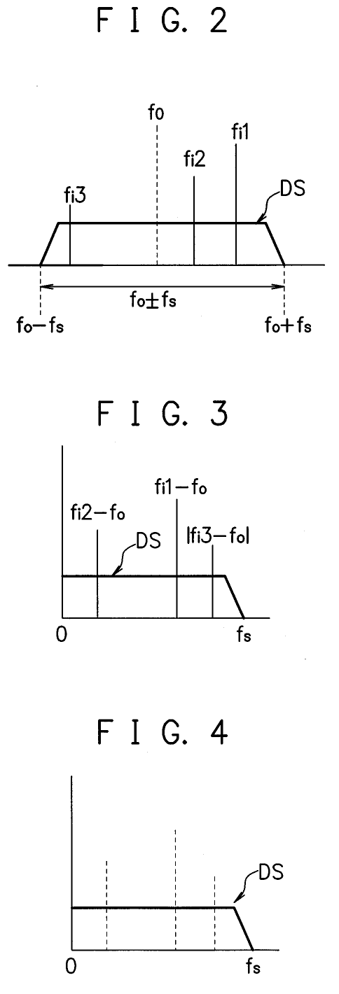

Next, the operation of detection and elimination of an interference signal by the spread spectrum system receiving device in this embodiment will be explained in detail with reference to FIG. 2 to FIG. 4. It should be mentioned that the gain control of the variable gain amplifier 6 is a basic operation of a demodulation circuit and is not a main element of the present invention, so that the explanation thereof is omitted. Note that in FIG. 2 to FIG. 4 hereinafter explained, the horizontal axis is frequency and the vertical axis is energy.

FIG. 2 is a diagram showing an example of the spectrum of the received signal. As shown in FIG. 2, interference signals of single frequencies fi1, fi2, and fi3 are superimposed in a situation where the spectrum is spread over a frequency band of ±fs with a frequency fo as a center, that is, within a frequency band from (fo−fs) to (fo+fs).

FIG. 3 shows a state in which this received signal is frequency-converted to a baseband signal by the mixer 4 in the aforementioned example of direct conversion. More specifically, a signal which was spread (spread signal) DS has a band from a frequency 0 Hz to a spread frequency fs, and the interference signal is frequency-converted to 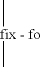
(x is a numerical subscript, and X=1, 2, 3).

The fast Fourier transform processing (FFT processing) of the digital data obtained by the conversion by the A/D converter 8 shown in FIG. 1 means finding the spectrum shown in FIG. 3 by a digital operation. It is easy to read the presence or absence of the single-frequency or narrow-band interference signal and its frequency from the spectrum shown in FIG. 3, whereby the interference signal contained in the received signal can be detected. Accordingly, it is also possible to eliminate the interference signal frequency component (or components) in the noise eliminator 12 based on the spectrum obtained by subjecting the received signal shown in FIG. 3 to the fast Fourier transform processing.

FIG. 4 shows a state in which the interference signal frequency component (or components) is (or are) eliminated from the spectrum shown in FIG. 3 (an output signal from the noise eliminator 12), and the received signal without interference can be regenerated by the inverse fast Fourier transform in the I-FFT processor 13. Thereafter, the received signal with no interference signal (the interference signal frequency component (or components) is (or are) eliminated therefrom) is subjected to the same inverse spread processing and demodulation processing as in a normal spread spectrum communication receiving device, and consequently the receive data can be obtained.

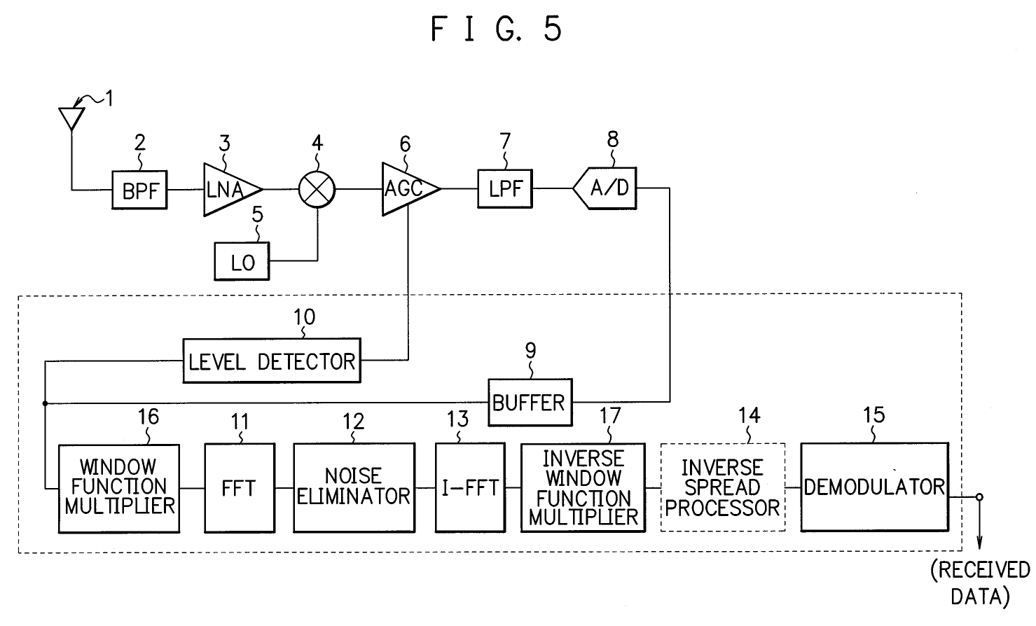

Although the following description is omitted to explain the principal in the aforementioned description, in the actual FFT processing, since finite and discrete data is subjected to Fourier transform, a frequency spectrum which does not originally exist (side lobe) occurs to thereby reduce frequency resolution, which causes trouble to detection and elimination of the interference signal frequency component (or components). To prevent this situation, the spread spectrum system receiving device of this embodiment is configured, for example, as shown in FIG. 5, and in the actual FFT processing, the digital data to be subjected to FFT processing is multiplied by an appropriate window function. FIG. 5 is a diagram showing an example of the concrete configuration of the spread spectrum system receiving device in this embodiment, reference numeral 16 denotes a window function multiplier for multiplying the digital data outputted from the A/D converter 8 by a window function, and reference numeral 17 denotes an inverse window function multiplier for multiplying an output from the I-FFT processor by an inverse window function. Note that the inverse window function multiplier 17 may not be provided as will be described later.

Because of the multiplication by the window function, a time-axis waveform, which is obtained in a case where the interference signal component (or components) is (or are) eliminated from the frequency spectrum found by the FFT processing and then subjected to the inverse FFT processing, was multiplied by the window function. Accordingly, to exactly regenerate the received signal waveform, it is necessary to multiply the time-axis waveform obtained by the inverse FFT processing by the inverse window function. However, only plus and minus signs of the signal which results from the inverse spread processing by the inverse spread processor 14 are necessary for the demodulation processing which will be performed after this, and hence, it is insignificant to omit the multiplication by the inverse window function. In particular, it is effective to select a value obtained by dividing time width corresponding to one bit of data by some integer as the time width to sample the data for the FFT processing when the soft decision of an inverse spread result is taken into consideration.

In the spread spectrum communication, with an increase in spread rate, the elimination rate with respect to single-frequency interference rises, which, however, causes an increase in occupied bandwidth at the same time. When radio communication is performed by weak radio waves, it is assumed as a precondition that single-frequency and narrow-band interference waves (interference signals) such as radio waves emitted from other communication equipment and radiation noise from electronic equipment exist, and hence there is a possibility that the increase in occupied bandwidth causes an increased influence of the aforementioned noise.

Therefore, according to the aforementioned embodiment, single-frequency and narrow-band noise (interference signals) in the spread spectrum communication can be eliminated, which makes it possible to improve the communication quality of the spread spectrum communication by weak radio waves, thereby leading to an increase in the utilization range of radio communication. Moreover, according to this embodiment, circuits associated with processing (FFT processing, noise elimination, inverse FFT processing, inverse spread processing, and demodulation processing) performed on the side of the stage subsequent to the A/D converter 8 are each composed of a digital circuit, although its circuit configuration becomes complicated, whereby IC implementation is easy, and a reduction in costs can be realized because of the manufacturing economies of scale and the like.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

1. A spread spectrum communication system receiving device for receiving a signal transmitted in a spread spectrum communication system, said receiving device, comprising:
an A/D converter for converting a received signal to digital data;
a Fourier transformer for subjecting the digital data outputted from said A/D converter to fast Fourier transform and detecting a frequency component associated with an interference signal from the obtained frequency spectrum of the received signal;
a noise eliminator for eliminating the frequency component associated with the interference signal based on a result of the detection in said Fourier transformer;
an inverse Fourier transformer for subjecting an output from said noise eliminator to inverse fast Fourier transform;
an inverse spread processor for subjecting an output from said inverse Fourier transformer to inverse spread processing; and
a demodulator for subjecting an output from said inverse spread processor to demodulation processing.

2. The receiving device according to claim 1, wherein said noise eliminator eliminates a frequency component whose energy is larger than a certain threshold level based on the result of the detection in said Fourier transformer.

3. The receiving device according to claim 1, wherein said noise eliminator judges whether energy of the received signal is larger than a certain threshold level for each frequency component based on the frequency spectrum of the received signal obtained in said Fourier transformer, and eliminates a frequency component whose energy is larger than the threshold level as a result of the judgment.

4. The receiving device according to claim 1, further comprising a multiplier for multiplying the digital data outputted from said A/D converter by a window function and outputting an operation result to said Fourier transformer.

5. The receiving device according to claim 4, wherein the window function is a window function for preventing a side lobe caused by the fast Fourier transform.

6. The receiving device according to claim 1, wherein said spread spectrum communication system receiving device frequency-converts the received signal in a direct conversion system.

7. The receiving device according to claim 1, further comprising a frequency converter for frequency-converting the received signal to baseband, wherein said A/D converter converts the frequency-converted received signal to the digital data.

8. A spread spectrum communication system receiving device having a function of eliminating a narrow-band interference frequency component in a spread spectrum communication system from a received signal, said receiving device, comprising:
an A/D converter for frequency-converting the received signal to baseband and then converting the resultant received signal to digital data;
a digital arithmetic circuit for subjecting the received signal digitized by said A/D converter to fast Fourier transform, and detecting and eliminating single-frequency and narrow-band interference frequency components from a frequency spectrum of the resultant received signal; and
a signal processor for subjecting the received signal processed in said digital arithmetic circuit to inverse fast Fourier transform to return the received signal to time-axis data, and subjecting the time-axis data to inverse spread processing and demodulation processing.

9. The receiving device according to claim 8, wherein said digital arithmetic circuit is composed of a CPU or a DSP.

10. The receiving device according to claim 8, wherein said digital arithmetic circuit comprises:
an interference signal detector for subjecting the received signal to the fast Fourier transform and detecting the single-frequency and narrow-band interference frequency components from the obtained frequency spectrum; and
a noise eliminator for eliminating the interference frequency components.
